(19) United States
(12) Patent Application Publication
(10) Pub. No.: US 2007/0234716 A1
(43) Pub. Date: Oct. 11, 2007

(54) Vehicular ejector system and controller and control method for vehicular ejector system

(75) Inventor: Shigemasa Hirooka, Susono-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 11/730,817

(22) Filed: Apr. 4, 2007

(30) Foreign Application Priority Data
Apr. 7, 2006 (JP) 2006-106309

(51) Int. Cl. F16D 31/02

(52) U.S. Cl. 60/397

(57) ABSTRACT

An ejector system for a vehicle includes an ejector which generates negative pressure that is greater than negative pressure provided from an intake passage of an intake system of an internal combustion engine, and supplies the generated negative pressure to a negative pressure chamber of a brake booster; a VSV that selectively renders the ejector operational or non-operational; and an ECU that controls the VSV. The ECU includes a blockage determining portion that determines whether there is a blockage in the ejector system according to a difference in the pressure in the negative pressure chamber and the pressure provided from the intake passage.

### INCORPORATION BY REFERENCE

The disclosure of Japanese Patent Application No. 2006-106309 filed on Apr. 7, 2006, including the specification, drawings and abstract is incorporated herein by reference in its entirety.

### BACKGROUND OF THE INVENTION

1. Field of the Invention

The invention relates to a vehicular ejector system, and a controller and control method of that vehicular ejector system. More particularly, the invention relates to a vehicular ejector system provided with an ejector that supplies negative pressure to a brake booster, as well as a controller and control method of that vehicular ejector system.

2. Description of the Related Art

Ejectors are sometimes used in vehicles to supply a brake booster with negative pressure greater than the negative pressure provided from the intake passage of an intake system of an internal combustion engine. The intake system provides communication between ambient air and each cylinder (hereinafter also referred to as “intake system of the internal combustion engine”). Japanese Patent Application Publication No. 2005-188332 (hereinafter referred to as “JP-A-2005-188332”), for example, describes an ejector system that includes a switching means for switching the state of the ejector between an operational state and a non-operational state, and a blockage determining means that determines whether the flow path of the ejector is obstructed or blocked based on the difference between the air amounts drawn into the intake pipe before and after the state of the ejector is switched by the switching means. That is, the ejector system described in JP-A-2005-188332 focuses on the change in the intake-air flow rate caused by operation of the ejector, and determines whether the flow path of the ejector is blocked based on the fact that the intake-air flow rate before and after the switching operation no longer changes when the ejector is blocked.

In recent years, there has been increasing concern over environmental issues such as global warming and air pollution. As a result, reducing the amount of exhaust emissions such as hydrocarbons in exhaust gas discharged from vehicles has become an important issue. One effective measure to achieve this is to quickly increase the temperature of a catalyst arranged in the exhaust system of an internal combustion engine to the catalyst reaction temperature. Thus, control is typically executed to retard the ignition timing of the internal combustion engine until a coolant temperature of the internal combustion engine reaches a prescribed temperature after the engine startup (hereinafter referred to as “during cold start of the internal combustion engine”). During this time, the throttle valve is also simultaneously controlled to widely open the intake passage to increase the flow rate of intake air (hereinafter these controls will be collectively referred to as “catalyst warm-up control”). Executing the catalyst warm-up control enables more air-fuel mixture to be combusted closer to the exhaust stroke so that hotter exhaust gas flows into the catalyst, thereby quickly increasing the catalyst temperature to the catalyst reaction temperature.

However, by widely opening the intake passage using the throttle valve, as described above, the negative pressure generated by the intake system of the internal combustion engine is reduced. Because the brake booster draws negative pressure from the intake system of the internal combustion engine, brake assist for a brake operation becomes insufficient in this case so the driver must exert more force when braking. Therefore, typically greater negative pressure is supplied to the brake booster using an ejector during cold start of the internal combustion engine based on the catalyst warm-up control described above. In this case, the intake passage is open relatively wide so the degree of change in the flow rate of the intake air decreases relatively even if the ejector is operated. As a result, changes in the flow rate of intake air do not cause unstable idling nor do they adversely affect the air-fuel ratio to a great extent. On the other hand, when the coolant temperature of the internal combustion engine reaches the prescribed temperature and the catalyst becomes activated, the catalyst warm-up control is no longer necessary so the opening amount of the throttle valve is properly reduced to lower the target engine revolutions in idling state in order to increase fuel efficiency. However, if the ejector is used in this case, it becomes difficult to control the target engine revolutions in idling state so the engine revolutions in idling state may become unstable. The simplest solution therefore would be to not operate the ejector. If the ejector is not operated, however, the following problems occur.

The ejector is a structure designed to generate a large negative pressure by the Venturi effect so the part of the passage that generates large negative pressure in the ejector is narrow or constricted. If the ejector is not operated for an extended period of time, this passage may easily become blocked due to the lack of intake air flowing through it. This blockage may result from any number of causes. For example, in the winter, moisture in the intake air may condense and collect in the passage and then freeze, thus blocking the passage. Also, intake air containing oil (such as PCV oil) may enter the ejector and adhere to the wall surface of the passage. The oil may then bind with debris on the wall surface such that deposits gradually accumulate and block the passage. Further, foreign matter that has entered the ejector may also block the passage.

When detecting blockage of the ejector, the ejector system described in JP-A-2005-188332, for example, can detect blockage of the ejector by the determination based on the flow rate of the intake air, appropriate measures must be taken ensure sufficient detection accuracy. For example, the determination must be made when the opening amount of the throttle valve is maintained at a fixed opening amount and after a high altitude correction has been performed.

### SUMMARY OF THE INVENTION

This invention thus provides a vehicular ejector system and a controller and control method of that vehicular ejector system which can better determine whether there is a blockage in the ejector system with little adverse effect on the determination accuracy.

A first aspect of the invention relates to an ejector system for a vehicle, which includes an ejector, an ejector state-changing device, and a controller. The ejector generates negative pressure that is greater than the negative pressure provided from the intake passage of the intake system of an internal combustion engine. The intake system provides communication between ambient air and each cylinder, and supplies the generated negative pressure to a negative pressure chamber of a brake booster. The ejector state-changing device selectively renders the ejector operational or non-operational. The controller controls the ejector state-changing device and includes a blockage determining portion that determines whether there is a blockage in the ejector system according to the difference between the pressure in the negative pressure chamber and the negative pressure provided from the intake passage. Although the amount of negative pressure supplied to the negative pressure chamber by the ejector also changes due to factors such as changes in altitude and changes in the opening amount of the throttle valve and the like, when the ejector is operating normally the negative pressure in the negative pressure chamber is generally greater than the negative pressure provided from the intake passage regardless of such factors. This suggests changes in the state of the ejector may be detected more accurately using the pressure in the negative pressure chamber rather than the flow rate of the intake air. This is because the flow rate of intake air is directly affected by various factors that affect the manner in which the intake air flows. In comparison, the pressure in the negative pressure chamber more stable because the pressure is not directly affected by disturbances. That is, the invention determines whether the ejector system is blocked according to the difference between the negative pressure provided from the intake passage and the pressure in the negative pressure chamber. Thus, the invention makes it possible to better determine whether there is a blockage in the ejector system.

Also, another aspect of the invention relates to an ejector system for a vehicle, which includes an ejector, an ejector state-changing device, and a controller. The ejector generates negative pressure that is greater than negative pressure provided from an intake passage of an intake system of an internal combustion engine, and supplies the generated negative pressure to a negative pressure chamber of a brake booster. The ejector state-changing device selectively renders the ejector operational or non-operational. The controller controls the ejector state-changing device and includes a blockage determining portion that determines whether there is a blockage in the ejector system according to a change in the pressure in the negative pressure chamber after the ejector state-changing device is controlled to render the ejector operational. When the ejector is operating normally, negative pressure that is greater than the negative pressure provided from the intake passage is supplied to the negative pressure chamber. After passing through a transitional state, the pressure in the negative pressure chamber becomes substantially constant. Also, this change can be easily detected as long as the ejector is operating normally. If, on the other hand, there is a blockage in the ejector system, either the negative pressure supplied to the negative pressure chamber will be about equal to or lower than the negative pressure provided from the intake passage, concomitantly the rate of the negative pressure change in this case also lessens. The invention, which aims to determine whether there is a blockage in the ejector system by detecting this change in state, is able to better make that determination.

Also, another aspect of the invention relates to an ejector system for a vehicle, which includes an ejector, an ejector state-changing device, and a controller. The ejector has an inlet side connecting portion and an outlet side connecting portion which are connected to an intake passage of an intake system of an internal combustion engine, a negative pressure generating portion that generates negative pressure from intake air flowing between the inlet side connecting portion and the outlet side connecting portion, and a negative pressure supply connecting portion that is communicated with the negative pressure generating portion and also connected to a brake booster. The ejector state-changing device selectively renders the ejector operational or non-operational. The controller controls the ejector state-changing device; and includes a blockage determining portion that determines whether there is a blockage in the ejector system according to a change in at least one pressure, from among the pressure generated between the intake passage and the inlet side connecting portion, the pressure generated between the intake passage and the outlet side connecting portion, and the pressure generated between the negative pressure generating portion and the negative pressure supply connecting portion.

Here, when the ejector operates normally, intake air is drawn from the intake passage to the inlet side connecting portion of the ejector so the pressure in the passage between the intake passage and the inlet side connecting portion changes. Similarly, intake air flows out from the outlet side connecting portion of the ejector into the intake passage so the pressure in the passage between the intake passage and the outlet side connecting portion also changes. Also, in the same way, negative pressure is supplied from the negative pressure generating portion of the ejector to the negative pressure supply connecting portion so the pressure in the passage between the negative pressure generating portion and the negative pressure supply connecting portion also changes. Hereinafter, these pressures will be referred to as detected ejector pressure. The changes in the state of these pressures can be sufficiently detected as long as the ejector is operating normally. If, on the other hand, there is a blockage in the ejector system, little or no intake air flows through so the pressure in these passages either remains the same or does not change much. Therefore, the invention, which aims to determine whether there is a blockage in the ejector system by detecting this change in state of these pressures, is able to better make that determination.

The detected ejector pressure may be detected by, for example, a pressure detecting device such as a pressure sensor, but the invention is not limited to this. That is, the detected ejector pressure may be determined using any suitable means. The blockage determining portion may determine that there is a blockage in the ejector system when, the difference in any one of the detected ejector pressure, for example, before and after the ejector state-changing device is controlled to render the ejector operational, is equal to or less than a predetermined value, i.e., when the change in the detected ejector pressure is small. Also, the blockage determining portion may determine that there is a blockage in the ejector system when, any one of the detected ejector pressure, for example, has not dropped below a predetermined value at least after the ejector state-changing device has been controlled to render the ejector operational. However, the invention is not limited to this. For example, the blockage determining portion may also make the determination based on various conditions according to a change in the detected ejector pressure. Further, the determination may be made based on either negative pressure or absolute pressure. Moreover, the change in pressure has the same meaning as described above.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram showing a schematic view of a vehicular ejector system according to one example embodiment of the invention;

FIG. 2 is a view showing a schematic view of the internal structure of an ejector shown in FIG. 1;

FIG. 3 is a flowchart of a routine executed by one ECU when determining whether the ejector is blocked;

FIG. 4 is a graph showing a schematic view of the relationship between the intake manifold negative pressure and the intake air flow rate;

FIG. 5 is a graph showing the change in engine revolutions and brake negative pressure following a change in the state of a vacuum switching valve;

FIG. 6 is a flowchart of a routine executed by another ECU when determining whether the ejector is blocked according to a change in the brake negative pressure when the vacuum switching valve is turned on;

FIG. 7 is a graph showing the change in detected ejector pressure following a change in the state of the vacuum switching valve;

FIG. 8 is a flowchart of a routine executed by still another ECU when determining whether the ejector is blocked according to a change in the detected ejector pressure when the vacuum switching valve is turned on; and

FIG. 9 is a flowchart of a routine executed by yet another ECU based on a portion of a combined program, from among determining programs, when it is determined that there is an abnormality in the ejector during cold start of the internal combustion engine, and furthermore, when determining again whether the ejector is blocked when the coolant temperature reaches the prescribed temperature.

### DETAILED DESCRIPTION OF THE PREFERRED EMBODIMENTS

In the following description and the accompanying drawings, the present invention will be described in more detail in terms of example embodiments.

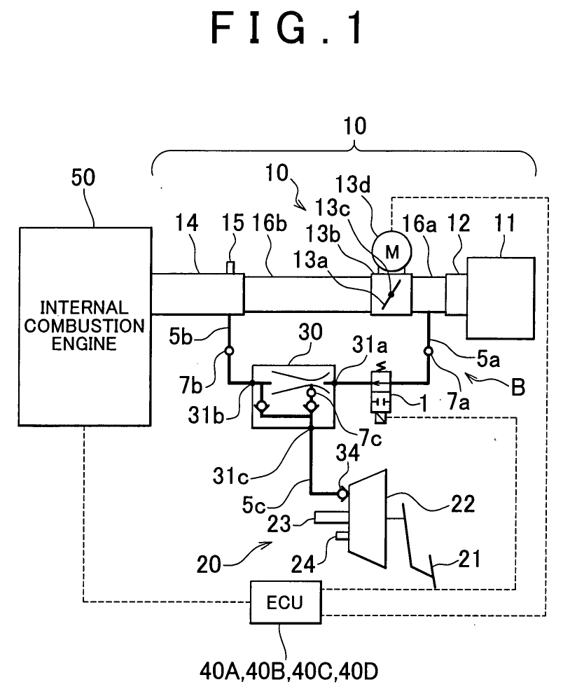

FIG. 1 is a diagram showing a schematic view of an ejector system for a vehicle (hereinafter referred to as “ejector system”) according to a first example embodiment of the invention. All of the structures shown in FIG. 1, including an internal combustion engine 50, are mounted in a vehicle, not shown. An intake system 10 of the internal combustion engine 50 includes an air cleaner 11, an airflow meter 12, an electric throttle 13, an intake manifold 14, an intake manifold pressure sensor 15, intake ports, not shown, which are communicated with the cylinders, also not shown, of the internal combustion engine 50, and intake pipes 16a and 16b and the like, for example, arranged appropriately between these structures. The air cleaner 11 filters the air drawn into the cylinders of the internal combustion engine 50 and is communicated with the ambient air via an air duct, not shown. The airflow meter 12 is used to measure the intake air flow rate and outputs a signal that indicates intake air flow rate.

The electric throttle mechanism 13 includes a throttle valve 13a, a throttle body 13b, a throttle valve shaft 13c, and an electric throttle motor 13d. The throttle valve 13a is used to adjust the total amount of intake air supplied to the cylinders of the internal combustion engine 50 by changing its opening amount. The throttle body 13b is made of a cylindrical member that forms part of the intake passage and supports the throttle valve shaft 13c of the throttle valve 13a arranged in this intake passage. The electric throttle motor 13d changes the opening amount of the throttle valve 13a according to the control by an ECU (Electronic Control Unit) 40A, which will be described later. A step motor may be used as the electric throttle motor 13d. The electric throttle motor 13d is fixed to the throttle body 13b and an output shaft, not shown, of the electric throttle motor 13d is connected to the throttle valve shaft 13c. The opening amount of the throttle valve 13a is detected by the ECU 40A based on an output signal from an encoder, not shown, provided in the electric throttle mechanism 13.

A throttle-by-wire system that uses an actuator to drive the throttle valve 13a, similar to the electric throttle mechanism 13, may be applied to the throttle mechanism so that air-fuel ratio correction control can also be simultaneously performed when an ejector 30, described later, is operated. However, the invention may also be used with a mechanical throttle mechanism that is linked to an accelerator pedal, not shown, via a wire for example, and changes the opening amount of the throttle valve 13a mechanically. The intake manifold 14 is a single intake passage on the upstream side, which then branches off to each cylinder of the internal combustion engine 50 on the downstream side to distribute intake air to each cylinder of the internal combustion engine 50. Also, the intake manifold pressure sensor 15 is provided in the intake manifold 14 to detect the pressure (hereinafter referred to as “intake manifold negative pressure Pin”) provided from the intake passage to a negative pressure chamber, not shown, of a brake booster 22, which will be described later.

A brake system 20 includes a brake pedal 21, the brake booster 22, a master cylinder 23, a negative pressure sensor 24, and a wheel cylinder, not shown. The brake pedal 21, which is operated by the driver to brake the rotation of a wheel, is connected to an input rod, not shown, of the brake booster 22. The brake booster 22 generates assist force at a predetermined multiplication force ratio (i.e., servo ratio) with respect to the pedal depression force. The divided negative pressure chamber on a master cylinder 23 side within the brake booster 22 is connected via the ejector 30 to the intake passage of the intake manifold 14. Also, the negative pressure sensor 24 is provided in the brake booster 22 as a pressure detecting device for detecting the pressure in this negative pressure chamber (hereinafter referred to as “brake negative pressure Pb”). An output rod, not shown, of the brake booster 22 is connected to an input shaft, also not shown, of the master cylinder 23. The master cylinder 23 generates hydraulic pressure in response to force applied by the brake booster 22. The master cylinder 23 is connected via a hydraulic pressure circuit to each wheel cylinder provided with a disc brake mechanism, not shown, on each wheel. The wheel cylinders generate braking force by the hydraulic pressure supplied from the master cylinder 23. The brake booster 22 is not particularly limited as long as it is a pneumatic system so a typical brake booster may be used.

The ejector 30 generates negative pressure provided from the intake passage of the intake system 10, more specifically, a greater negative pressure than the intake manifold negative pressure Pm, and supplies that negative pressure to the negative pressure chamber of the brake booster 22. The ejector has an inlet port (inlet side connecting portion) 31a, an outlet port (outlet side connecting portion) 31b, and a negative pressure supply port (connecting portion for supplying negative pressure) 31c. The negative pressure supply port 31c is connected to the negative pressure chamber of the brake booster 22 by an air hose 5c. Also, the inlet port 31a is connected by an air hose 5a to the intake passage of the intake pipe 16a, and the outlet port 31b is connected by an air hose 5b to the intake passage of the intake manifold 14 such that the electric throttle mechanism 13, or more particularly, the throttle valve 13a, is sandwiched in between. Accordingly, a bypass B which bypasses the electric throttle mechanism 13 is formed by the air hoses 5a and 5b and includes the ejector 30. When the ejector 30 is not operating, intake manifold negative pressure Pm is supplied to the negative pressure chamber of the brake booster 22 from the intake passage of the intake manifold 14 via the air hose 5b, the outlet port 31b and negative pressure supply port 31c of the ejector 30, and the air hose 5c.

A pressure sensor 7a is provided in the air hose 5a to detect an ejector pressure Pva that is generated between the intake passage and the inlet port 31a. Similarly, a pressure sensor 7b is provided in the air hose 5b to detect an ejector pressure Pvb that is generated between the intake passage and the outlet port 31b, and a pressure sensor 7c is provided in the internal flow path that provides communication between a negative pressure ejecting portion (i.e., negative pressure generating portion) 32c, described later, and the negative pressure supply port 31c, to detect an ejector pressure Pvc that is generated between the negative pressure ejecting portion 32c and the negative pressure supply portion 31c. More specifically, the pressure sensor 7c is arranged closer to the negative pressure ejecting portion 32c than a check valve 34. Also, according to the example embodiment, these pressure sensors 7a, 7b, and 7c may be arranged as described in a third example embodiment, which will be described later, or omitted.

A vacuum switching valve (VSV) 1 is interposed in the air hose 5a. The VSV 1 serves to communicate or cut off the bypass B according to control performed by the ECU 40A. In this example embodiment, a normally closed solenoid valve with two positions and two ports is used as the VSV 1, but the invention is not limited to this. To the contrary, any suitable electromagnetic valve or the like may be used or a flow rate regulating valve that can control the degree to which the flow path is blocked may also be used, for example. Further, the VSV 1 is structured to selectively render the ejector 30 operational or non-operational operate by communicating or cutting off the bypass B. In this example embodiment, the VSV 1 functions as an ejector state-changing device.

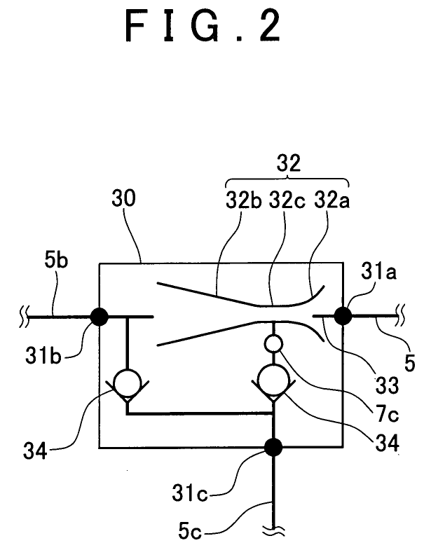

FIG. 2 is a view showing a schematic view of the internal structure of the ejector 30. Inside the ejector 30 is a diffuser 32. The diffuser 32 includes a convergent tapered portion 32a, a divergent tapered portion 32b, and a negative pressure ejecting portion 32c which is a passage connecting the convergent tapered portion 32a and the divergent tapered portion 32b. The convergent tapered portion 32a opens toward the inlet port 31a while the divergent tapered portion 32b opens toward the outlet port 31b. Also, the negative pressure ejecting portion 32c is connected to the negative pressure supply port 31c. A nozzle 33 that injects the drawn in intake air toward the convergent tapered portion 32a is provided in the inlet port 31a. The intake air injected from the nozzle 33 flows through the diffuser 32 and out of the outlet port 31b into the air hose 5b. At this time, the diffuser 32 produces a fast injection flow such that a large negative pressure is generated in the negative pressure ejecting portion 32c by the Venturi effect. This negative pressure is then supplied from the negative pressure supply port 31c to the negative pressure chamber through the air hose 5c. This kind of function by the ejector 30 enables the brake booster 22 to generate greater negative pressure than the intake manifold negative pressure Pm. Incidentally, check valves 34 provided in the internal flow path between the negative pressure ejecting portion 32c and the negative pressure supply port 31c, in the internal flow path between the outlet port 31b and the negative pressure supply port 31c, and in the connecting portion of the air hose 5c of the brake booster 22 all serve to prevent backflow. Also, the ejector is not limited to the ejector 30 having the internal structure shown in FIG. 2. That is, an ejector having another internal structure may be applied instead of the ejector 30.

The ECU 40A includes a CPU (Central Processing Unit), ROM (Read Only Memory), RAM (Random Access Memory), input/output circuits, and the like. The ECU 40A mainly controls the internal combustion engine 50, and in this example embodiment, also controls the VSV 1. The ROM stores programs that specify various routines that are executed by the CPU. In this example embodiment, in addition to programs for controlling the internal combustion engine 50, the ROM also stores a program for controlling the VSV 1 and a program for determining whether there is a blockage in the ejector system due to, for example, blockage of the ejector 30. However, these programs may also be combined into a single program. In this example embodiment, a blockage determining portion is realized by the CPU, ROM, RAM, and the portion of the program stored in the ROM that specifies the routine for determining whether there is a blockage in the ejector system. Also, in this example embodiment, the ejector system is realized by the VSV 1, the ejector 30, and the ECU 40A.

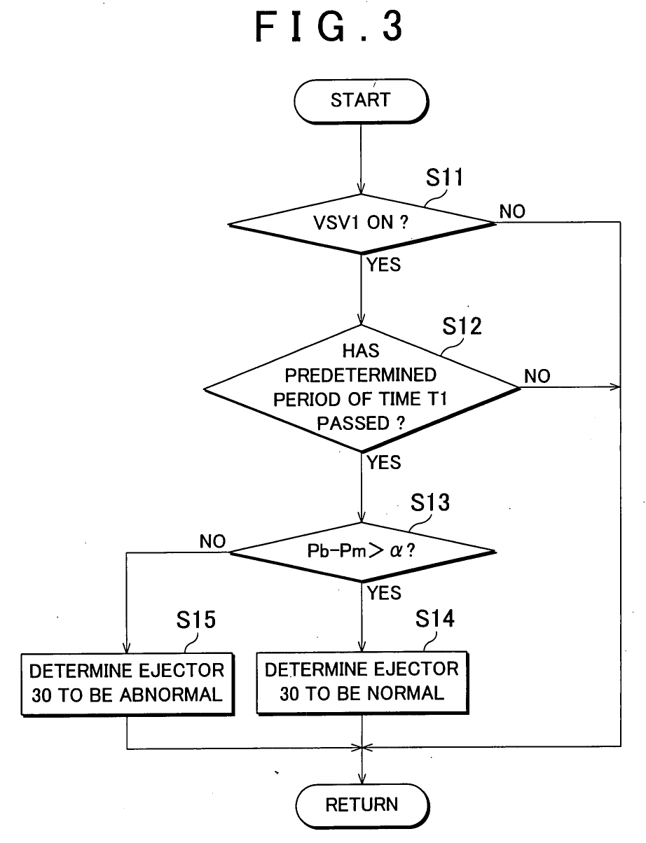

Next, the routine performed by the ECU 40A when determining whether there is a blockage in the ejector system due to blockage of the ejector 30, for example, will be described in detail with reference to the flowchart shown in FIG. 3. Hereinafter, an example will be described in which the ejector system is blocked due to blockage of the ejector 30. The ECU 40A determines whether the ejector 30 is blocked by having the CPU repeatedly execute the routine shown in the flowchart in extremely short period of time based on the program for determining blockage that is stored in the ROM. The CPU determines whether the VSV 1 has been controlled to operate the ejector 30 (i.e., whether the VSV 1 has been turned on) (step S11). This determination can be made by the CPU checking the state of the internal processing based on the program for controlling the VSV 1 performed by the ECU 40A. However, the invention is not limited to this. That is, when the VSV 1 is provided with a limit switch or the like that can detect the operating state of the VSV 1, for example, that determination may also be made based on an output signal from the limit switch.

If the determination in step S11 is YES, the CPU then determines whether a predetermined period of time T1 has passed after the VSV 1 was turned on (step S12). This predetermined period of time T1 is preferably at least longer than the period of time that it takes for the brake negative pressure Pb to temporarily stop changing, i.e., is preferably a period of time during which the brake negative pressure Pb stabilizes. If the determination in step S12 is YES, the CPU detects the brake negative pressure Pb based on the output signal from the negative pressure sensor 24 and detects the intake manifold negative pressure Pm based on the output signal from the intake manifold pressure sensor 15, and then determines whether the difference between the brake negative pressure Pb and the intake manifold negative pressure Pm is greater than a predetermined value α (step S13). The predetermined value α is not limited as long as it is greater than zero. The greater the value of the predetermined value α, the more severe the determining conditions. Thus, blockage, for example, due to a deposit may be detected in the stage of showing blockage signs. Furthermore, instead of using the intake manifold negative pressure Pm in step S13, an estimated intake manifold negative pressure Pms, which will be described later, may be used. If the determination in step S13 is YES, the CPU determines that the ejector 30 is not blocked, i.e., that the ejector 30 is normal (step S14). If, on the other hand, the determination in step S13 is NO, the CPU determines that the ejector 30 is blocked, i.e., that there is an abnormality in the ejector 30 (step S15).

Incidentally, if the determination in either of steps S11 or 12 is NO, the CPU repeats step S11. Also, if it is determined in step S15 that there is an abnormality in the ejector 30, the CPU executes a process to illuminate a warning lamp indicating that there is an abnormality provided on an instrument panel, for example. Accordingly, the abnormality may be discovered early on so that steps to correct the abnormality may be taken promptly. Also, in this example embodiment, the time when the VSV 1 is turned on is determined in step S11, but the invention is not limited to this. Instead, in step S11 it may be determined whether the VSV 1 is already on. Also, in the example embodiment, the intake manifold negative pressure Pm is used in step S13. Alternatively, however, the estimated intake manifold negative pressure Pms, as described below, for example, may be used.

FIG. 4 is a graph showing a schematic view of the relationship between the intake manifold negative pressure Pm and the intake air flow rate. In the drawing, the vertical axis represents the intake air flow rate and the horizontal axis represents the intake manifold negative pressure Pm. Also in the drawing, the intake manifold negative pressure Pm is shown by absolute pressure. When the internal combustion engine 50 is started-up and the intake air flow rate increases, the intake manifold negative pressure Pm gradually increases from atmospheric pressure as shown by the curved line Ca. The opening amount of the throttle valve 31a at this time is small. Also, when the throttle valve 31a is at half throttle, the intake manifold negative pressure Pm increases as shown by the curved line Cb. Furthermore, when the opening amount of the throttle valve 31a is large, the intake manifold negative pressure Pm increases as shown by the curved line Cc.

On the other hand, when the opening amount of the throttle valve 31a increases, the revolution of the internal combustion engine 50 also increases. This relationship is shown by the straight lines Sa, Sb, and Sc, which correspond to operation of the internal combustion engine 50 at low, medium, and high revolutions, respectively, in FIG. 4. Therefore, when the throttle valve 31a is at half throttle and the internal combustion engine 50 is operating at medium revolution, for example, a point P1 is obtained as the point of intersection between the straight line Sb and the curved line Cb based on the relationship shown in FIG. 4, and the estimated intake manifold negative pressure Pms shown by point P2 may be obtained from this intersecting point P1. That is, once the opening amount of the throttle valve 31a and the revolution of the internal combustion engine 50 are determined, the estimated intake manifold negative pressure Pms may be obtained based on the relationship shown in FIG. 4. Incidentally, the estimated intake manifold negative pressure Pm taking into account the increase in the intake air flow rate when the ejector 30 is operated, in addition to the relationship shown in FIG. 4, may also be used. Accordingly, an ejector system for a vehicle and an ECU 40A can be realized which could better determine whether the ejector 30 is blocked with little adverse affect from disturbance on the determining accuracy.

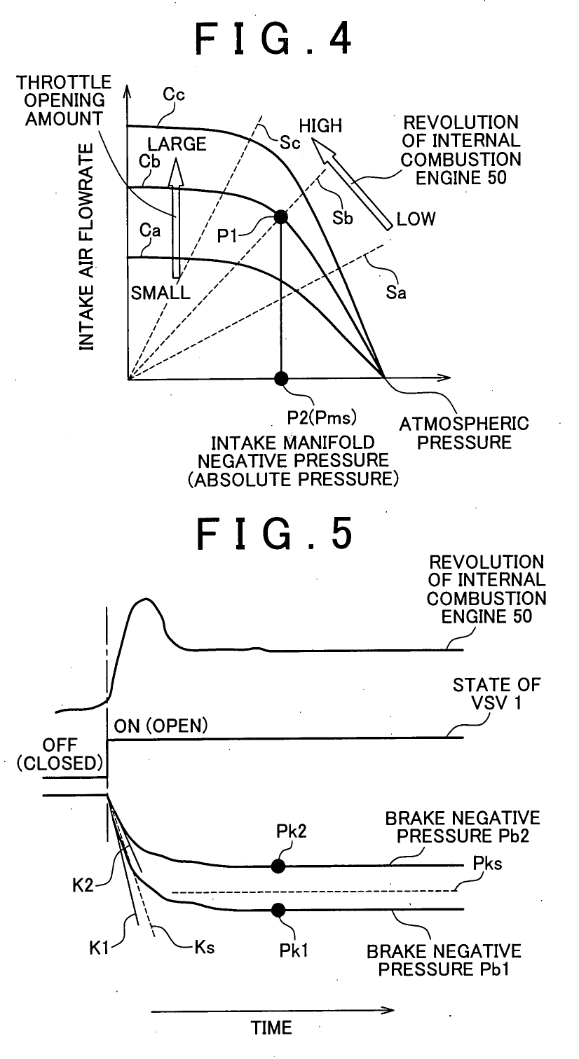

An ejector system according to a second example embodiment of the invention is similar to the ejector system according to the first example embodiment except that it is provided with an ECU 40B instead of the ECU 40A shown in FIG. 1. Also, the ECU 40B is the same as the ECU 40A except that the program for determining blockage stored in the ROM is different. Also, the structure of the vehicle to which the ejector system of the second example embodiment is applied is the same as the structure shown in FIG. 1 with the exception of the ECU 40A. With the ejector system according to the second example embodiment, blockage of the ejector 30 is determined according to a change in the brake negative pressure Pb when the VSV 1 is turned on. FIG. 5 is a graph showing the change in revolutions of the internal combustion engine 50 and brake negative pressure Pb following a change in state of the VSV 1. In the drawing, the brake negative pressure Pb when the ejector 30 is operating normally is designated brake negative pressure Pb1, while the brake negative pressure Pb when the ejector 30 is blocked (in this case, when signs of a blockage first appear) is designated brake negative pressure Pb2. Also in FIG. 5, the brake negative pressures Pb1 and Pb2 are shown by absolute pressures.

When the VSV 1 is turned on, the intake air flow rate increases thus causing revolution of the internal combustion engine 50 to increase as well. At the same time, negative pressure is supplied from the ejector 30 to the negative pressure chamber so when the ejector is operating normally, the brake negative pressure Pb1 increases, i.e., the pressure itself decreases. Once a certain negative pressure is supplied to the negative pressure chamber, the brake negative pressure Pb1 gradually approaches the negative pressure that can be supplied by the ejector 30. The brake negative pressure Pb1 then stabilizes after it passes through a transitional state. Also, the increased intake air flow rate starts to decrease as the brake negative pressure Pb1 approaches negative pressure that can be supplied. Moreover, when the brake negative pressure Pb1 stabilizes, the intake air flow rate stops decreasing and stabilizes.

On the other hand, if the ejector 30 is blocked, for example, the brake negative pressure Pb2 still increases when the VSV 1 is turned on but the magnitude of the change is less than that of the brake negative pressure Pb1. The degrees of change in the brake negative pressures Pb1 and Pb2 are indicated as slopes K1 and K2. Thus, by setting a predetermined value Ks between these slopes K1 and K2 it is possible to determine whether the ejector 30 is blocked from the relationship between the slope K and the predetermined value Ks. In this embodiment, the slopes K1 and K2 indicate the degree of initial change in the absolute pressures of the brake negative pressure Pb1 and Pb2 immediately after the VSV 1 is turned on. These slopes K1 and K2 are calculated by differentiating the amount of initial change in the absolute pressures of the brake negative pressure Pb1 and Pb2. Also, when the ejector 30 is blocked, it is unable to generate a large negative pressure by that much resulted from the blockage. Therefore, the brake negative pressure Pb2 in the stable state is less than the brake negative pressure Pb1 in the stable state. The amounts of the absolute pressures of the brake negative pressures Pb1 and Pb2 in the stable state are indicated by peak values Pk1 and Pk2. Therefore, setting a predetermined value Pks between these peak values Pk1 and Pk2 enables blockage in the ejector 30 to be determined by the relationship between the peak value Pk and the predetermined value Pks.

The peak value Pk in this example embodiment refers to the amount of absolute pressure of the brake negative pressure Pb in a stable state and does not necessarily have to be the lowest of the absolute pressures of the brake negative pressures Pb in a stable state. That is, the peak value Pk refers to the absolute pressure of the brake negative pressure Pb at a predetermined time in a stable state. Also, the absolute pressure of the brake negative pressure Pb can also be detected when it is in the transitional state and blockage of the ejector 30 can be determined by that amount. However, in this case, the farther before the stable state the determination is made the more difficult it is to accurately detect a brake negative pressure Pb, which results in reduced determining accuracy.

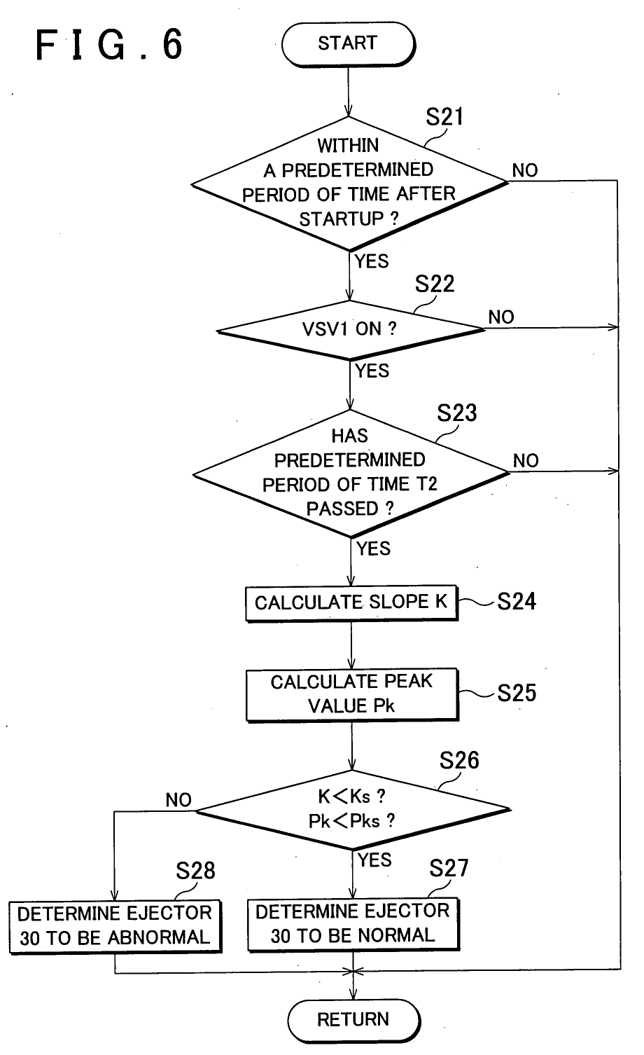

Based on the change in the brake negative pressure Pb described above, in the ejector system according to this example embodiment, the ECU 40B determines whether the ejector 30 is blocked or not by means of the following control. FIG. 6 is a flowchart of a routine executed by the ECU 40B when determining whether the ejector 30 is blocked according to a change in the brake negative pressure Pb when the VSV 1 is turned on. The CPU determines whether the period of time that has passed after the internal combustion engine 50 is started is still within a predetermined period of time (step S21). That is, in this example embodiment it is determined whether the period of time that has passed after the internal combustion engine 50 was started up is still within a predetermined period of time in order to determine whether the ejector 30 is blocked when the VSV 1 is first turned on. By making the determination within a predetermined period of time after starting the internal combustion engine 50 it is possible to determine whether the ejector 30 is blocked before the vehicle starts to move, but the invention is not limited to this. Alternatively, the determination as to whether the ejector 30 is blocked may also be made when the VSV 1 is turned on at another time. If the determination in step 21 is YES, the CPU determines whether the VSV 1 is turned on (step S22). If the determination in step 22 is also YES, the CPU determines whether a predetermined period of time T2 has passed after the VSV 1 is switched on (step S23). The predetermined period of time T2 is generally longer than the period of time necessary for the brake negative pressure Pb to stop changing temporarily, i.e., is preferably a period of time during which brake negative pressure Pb stabilizes.

If the determination in step 23 is YES, the CPU calculates the slope K, which indicates the degree of initial change in the absolute pressure of the brake negative pressure Pb (step S24). In this example embodiment, the smaller the slope K (i.e., the larger the negative value), the greater the degree of the pressure change and the lower the pressure (i.e., the greater the negative pressure) because the brake negative pressure Pb is detected by the absolute pressure. Next, the CPU calculates the peak value Pk of the absolute pressure of the brake negative pressure Pb in a stable state (step S25). The lower the pressure (i.e., the greater the negative pressure), the smaller this peak value Pk as well.

Continuing on, the CPU determines whether the slope K is smaller than the predetermined value Ks and determines whether the peak value Pk is less than the predetermined value Pks. Then the CPU determines whether both of these conditions are satisfied (step S26). The invention is not limited to this, however. For example, the CPU may determine whether only one of those conditions is satisfied. If the determination in step S26 is YES, the CPU determines that the ejector 30 is normal (step S27). If, however, the determination in step S26 is NO, the CPU determines that there is an abnormality in the ejector 30 (step S28). When it has been determined in step S28 that there is an abnormality in the ejector 30, the CPU may execute a process to alert the driver that there is an abnormality, just as in the first example embodiment. Also, if the determination in any one of steps S21, 22, and 23 is NO, the CPU repeats step S21. Accordingly, an ejector system for a vehicle and an ECU 40B can be realized which could better determine whether the ejector 30 is blocked with little adverse affect from disturbance on the determining accuracy.

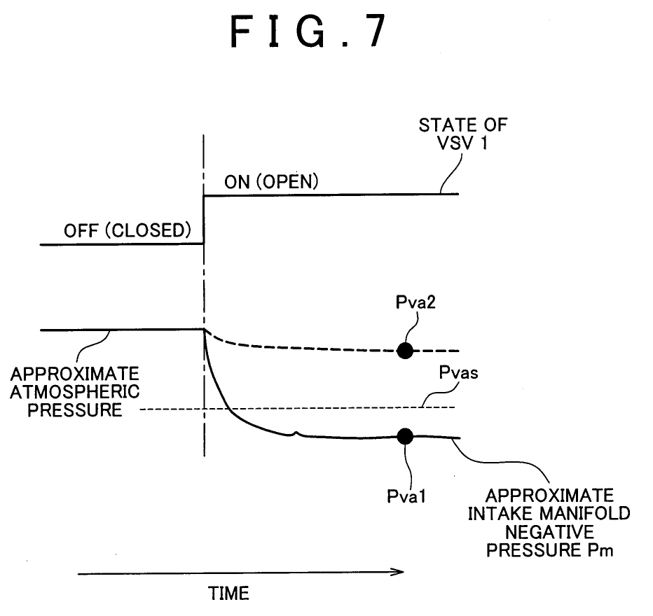

An ejector system according to a third example embodiment of the invention is similar to the ejector system according to the first example embodiment except for that it is provided with an ECU 40C instead of the ECU 40A. Also, the ECU 40C is the same as the ECU 40A except that the program for determining blockage stored in the ROM is different. Also, the structure of the vehicle to which the ejector system of the third example embodiment is applied is the same as the structure shown in FIG. 1 with the exception of the ECU 40A. With the ejector system according to the third example embodiment, blockage of the ejector 30 is determined according to a change in the detected ejector pressure Pva, Pvb, and Pvc when the VSV 1 is turned on. FIG. 7 is a graph showing the change in detected ejector pressure Pva following a change in the state of the VSV 1. Incidentally, it is possible to determine whether or not there is a blockage in the ejector system according to this example embodiment, such as in the ejector 30, if a change in at least one of the pressures, from among the detected ejector pressure Pva, Pvb, and Pvc, is detected. Accordingly, FIG. 7 shows a case in which the detected ejector pressure Pva is used as a representative detected ejector pressure. Also in FIG. 7, the detected ejector pressure Pva when the ejector 30 is operating normally is designated Pva1 and the detected ejector pressure Pva when the ejector 30 is blocked is designated Pva2. Also in FIG. 7, the detected ejector pressure Pva1 and Pva2 are shown by absolute pressures.

When the VSV 1 is turned on, the detected ejector pressure Pva1 passes from approximately atmospheric pressure through a transitional state and stabilizes at approximately the intake manifold negative pressure Pm. On the other hand, the absolute pressure of the detected ejector pressure Pva2 does not change much even when the VSV 1 is turned on because only an extremely small amount of intake air passes through the diffuser 32. Therefore, if a predetermined value Pvas is set between the detected ejector pressure Pva1 and Pva2, blockage of the ejector 30 can be determined by the relationship between the detected ejector pressure Pva and the predetermined value Pvas. Incidentally, in the case of the detected ejector pressure Pva as well, blockage of the ejector 30 may also be detected by the slope indicating the degree of initial change in the detected ejector pressure Pva, for example, similar to with the brake negative pressure Pb shown in FIG. 5. However, the pressure change in the transitional state is more abrupt with the detected ejector pressure Pva than it is with the brake negative pressure Pb. Therefore, when determining blockage of the ejector 30 using the detected ejector pressure Pva it is preferable to use the detected ejector pressure Pva in the stable state.

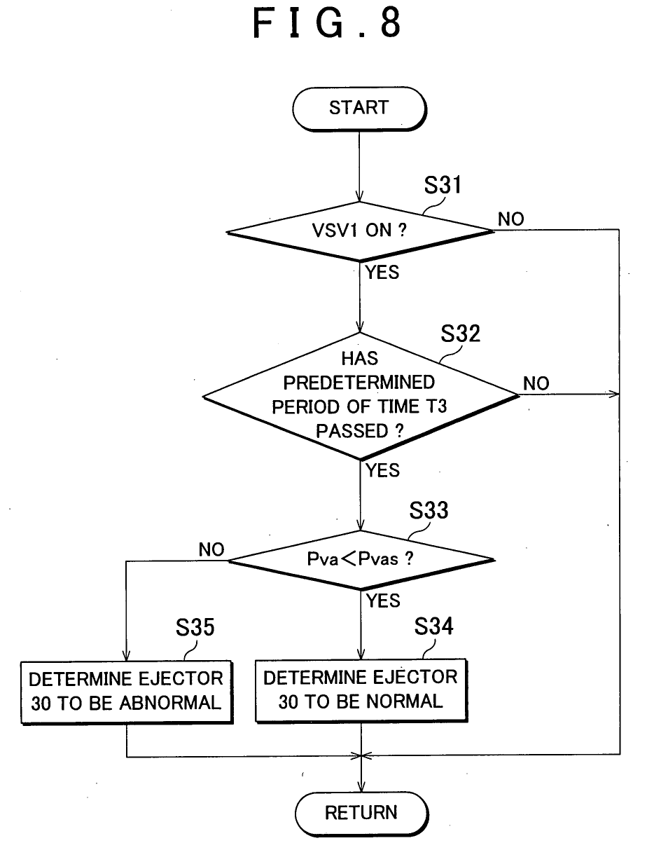

Based on the change in the detected ejector pressure Pva described above, in the ejector system according to this example embodiment, blockage of the ejector 30 is determined by having the ECU 40C perform the following control. FIG. 8 is a flowchart of a routine executed by ECU 40C when determining whether the ejector 30 is blocked according to a change in the detected ejector pressure Pva when the VSV 1 is turned on. The CPU first determines whether the VSV 1 has been turned on (step S31). If the determination in step S31 is YES, the CPU then determines whether a predetermined period of time T3 has passed after the VSV 1 was switched on (step S32). The predetermined period of time T3 is preferably longer than the time it takes the detected ejector pressure Pva to temporarily stop changing, i.e., is preferably a period of time during which the detected ejector pressure Pva stabilizes.

If the determination in step S32 is YES, the CPU detects the detected ejector pressure Pva in the stable state and determines whether that ejector determined pressure Pva is less than a predetermined value Pvas (step S33). If the determination in step S33 is YES, the CPU determines that the ejector 30 is normal (step S34). If, on the other hand, the determination in step S33 is NO, the CPU determines that there is an abnormality in the ejector 30 (step S35). If it has been determined in step S35 that there is an abnormality in the ejector 30, the CPU may execute a process to alert the driver that there is an abnormality, just as in the first example embodiment. Also, if the determination in either step S31 or step S32 is NO, the CPU repeats step S31.

Incidentally, in this example embodiment, the timing at which the VSV 1 is turned (i.e., becomes) on is determined in step S31, but the invention is not limited to this. Instead, in step S31 it may be determined whether the VSV 1 is already on. Also, in this example embodiment, whether the VSV 1 is turned on is determined in step S31 and whether there is a blockage in the ejector 30 is determined when the VSV 1 is on. Instead, however, whether or not the VSV 1 is turned off may be determined in step S31 and whether or not there is a blockage in the ejector 30 may be determined when the VSV 1 is off. In this case, for example, the CPU may determine the ejector 30 to be normal if a change in the detected ejector pressure Pva between either before the ejector 30 is turned off or immediately after the ejector 30 is turned off and after the predetermined period of time has passed T3 is greater than a predetermined value in step S33. Furthermore, the CPU can also determine whether the ejector 30 is blocked when the VSV 1 is turned off in addition to when the VSV 1 is turned on. In this case, the determination performed when the VSV 1 is turned off may function as double-checking of a blockage in the ejector 30. Accordingly, an ejector system for a vehicle and an ECU 40C can be realized which could better determine whether the ejector 30 is blocked with little adverse affect from disturbance on the determining accuracy.

An ejector system according to a fourth example embodiment of the invention is similar to as the ejector system according to the first example embodiment except for that it is provided with an ECU 40D instead of the ECU 40A. Also, the ECU 40D is the same as the ECU 40A except that the program for determining blockage that is stored in the ROM is different. Also, this program for determining blockage is the same as the program for determining blockage that is stored in the ECU 40A except that it also includes a combination program that combines with the program for determining a blockage, which is stored in the ECU 40A. However, the invention is not limited to this. That is, this combination program may also be combined with the program for determining blockage that is stored in the ECU 40B or the ECU 40C, for example. Also, the structure of the vehicle to which the ejector system of this example embodiment is applied is the same as that shown in FIG. 1 with the exception of the ECU 40A. Incidentally, in this example embodiment, the engine state determining portion that determines whether the internal combustion engine is during cold start is realized by the CPU, the ROM, the RAM, and the portion that performs the process shown in step S42, to be described later, in the program stored in the ROM.

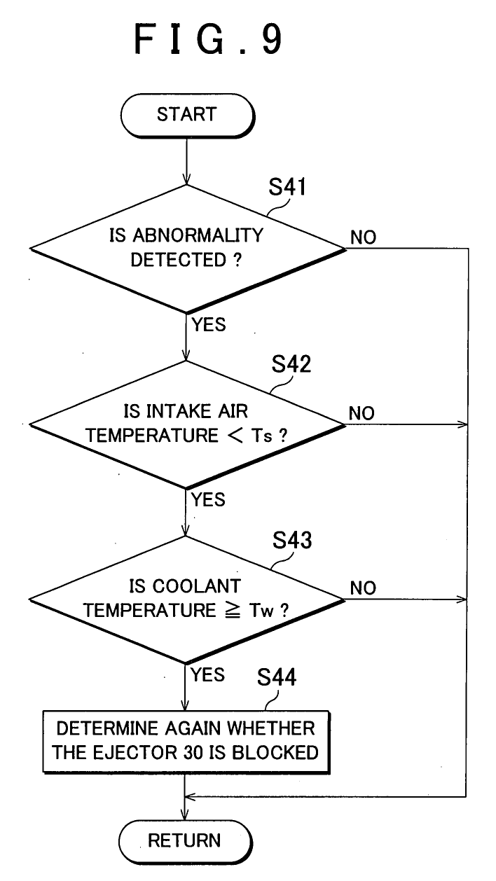

FIG. 9 is a flowchart of a routine executed by the ECU 40D based on a portion of a combined program, from among the determining programs, when it is determined that there is an abnormality in the ejector 30 during cold start of the internal combustion engine, and further, when determining again whether the ejector is blocked when the coolant temperature reaches the prescribed temperature. The CPU first determines whether an abnormality has been detected in the ejector 30 (step S41). If the determination in step S41 is YES, the CPU then determines whether the intake air temperature when the abnormality was detected was less than a predetermined temperature Ts (step S42). In this step it is estimated whether it was determined that there was an abnormality in the ejector 30 during cold start of the internal combustion engine. The ambient air temperature, for example, may also be used instead of the intake air temperature. If the determination in step S42 is YES, the CPU then determines whether the coolant temperature of the internal combustion engine 50 is higher than a threshold value Tw (step S43). If the determination in step S43 is NO on the other hand, the CPU repeats the processes shown in steps S41 to S43 until the coolant temperature of the internal combustion engine reaches the prescribed temperature. If the determination in step S43 is YES, the CPU performs a process in order to determine again whether the ejector 30 is blocked (step S44). The process shown in step S44 corresponds to the routine shown in the flowchart in FIG. 3 described above in the first example embodiment. Accordingly, if it is again determined that the ejector 30 is normal, it can be easily assumed that the blockage of the ejector 30 was caused by frozen moisture. Also, when it is actually determined that the ejector 30 is normal in step S44, the determination of “abnormal” during cold start of the internal combustion engine can be cleared. As a result, even if a process is performed to alert the driver of the abnormality, for example, the driver can be promptly notified that operation of the ejector 30 has returned to normal. Incidentally, if the determination is NO in either of steps S41 or S42, the CPU again executes the process shown in step S41. Accordingly, an ejector system for a vehicle and an ECU 40D can be realized which make it possible to better determine blockage of an ejector 30 with little adverse affect from disturbance on the determination accuracy, by even determining whether frozen moisture is causing a blockage in the ejector 30.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. An ejector system for a vehicle, comprising:
an ejector that generates a negative pressure greater than the negative pressure provided from an intake passage of an intake system of an internal combustion engine, and supplies the generated negative pressure to a negative pressure chamber of a brake booster;
an ejector state-changing device that selectively renders the ejector operational or non-operational; and
a controller that controls the ejector state-changing device and includes a blockage determining portion that determines whether there is a blockage in the ejector system according to a difference between a pressure in the negative pressure chamber and the negative pressure provided from the intake passage.

2. The ejector system for a vehicle according to claim 1, wherein the blockage determining portion determines that there is a blockage in the ejector system when the difference between the pressure in the negative pressure chamber and the negative pressure provided from the intake passage is equal to or less than a predetermined value.

3. The ejector system for a vehicle according to claim 1, wherein the blockage determining portion determines whether there is a blockage in the ejector system after the ejector state-changing device has rendered the ejector operational.

4. The ejector system for a vehicle according to claim 3, wherein the blockage determining portion determines whether there is a blockage in the ejector system after a predetermined period of time has passed from the time the ejector state-changing device renders the ejector operational.

5. An ejector system for a vehicle, comprising:
an ejector that generates a negative pressure greater than the negative pressure provided from an intake passage of an intake system of an internal combustion engine, and supplies the generated negative pressure to a negative pressure chamber of a brake booster;
an ejector state-changing device that selectively renders the ejector operational or non-operational;
a controller that controls the ejector state-changing device and includes a blockage determining portion that determines whether there is a blockage in the ejector system according to a change in a pressure in the negative pressure chamber after the ejector state-changing device has rendered the ejector operational.

6. The ejector system for a vehicle according to claim 5, wherein the blockage determining portion determines that there is a blockage in the ejector system when an amount of change in the pressure in the negative pressure chamber is equal to or less than a predetermined amount of change.

7. The ejector system for a vehicle according to claim 5, wherein the blockage determining portion determines that there is a blockage in the ejector system when a rate of change in the pressure in the negative pressure chamber is equal to or less than a predetermined rate of change immediately after the ejector state-changing device has rendered the ejector operational.

8. The ejector system for a vehicle according to claim 5, wherein the blockage determining portion determines whether there is a blockage in the ejector system after a predetermined period of time has passed from the time the ejector state-changing device renders the ejector operational.

9. An ejector system for a vehicle, comprising:
an ejector having an inlet side connecting portion and an outlet side connecting portion, which are connected to an intake passage of an intake system of an internal combustion engine, a negative pressure generating portion that generates negative pressure from intake air flowing between the inlet side connecting portion and the outlet side connecting portion, and a negative pressure supply connecting portion that is communicated with the negative pressure generating portion and also connected to a brake booster;
an ejector state-changing device that selectively renders the ejector operational or non-operational;
a controller which controls the ejector state-changing device and includes a blockage determining portion that determines whether there is a blockage in the ejector system according to a change in at least one of the pressure generated between the intake passage and the inlet side connecting portion, the pressure generated between the intake passage and the outlet side connecting portion, and the pressure generated between the negative pressure generating portion and the negative pressure supply connecting portion.

10. The ejector system for a vehicle according to claim 9, wherein the blockage determining portion determines whether there is a blockage in the ejector system after the ejector state-changing device has rendered the ejector operational.

11. The ejector system for a vehicle according to claim 9, wherein the blockage determining portion determines whether there is a blockage in the ejector system after the ejector state-changing device has rendered the ejector non-operational.

12. The ejector system for a vehicle according to claim 1, further comprising an engine state determining portion that determines whether a coolant temperature of the internal combustion engine is equal to or greater than a prescribed temperature,
wherein when the blockage determining portion has determined that there was a blockage in the ejector system and the engine state determining portion has also determined that the coolant temperature was below the prescribed temperature, the blockage determining portion determines again whether there is a blockage in the ejector system when the coolant temperature becomes equal to or greater than the prescribed temperature.

13. A controller used in the ejector system for a vehicle according to claim 1.

14. A control method of an ejector system for a vehicle, comprising:
rendering operational an ejector which generates negative pressure that is greater than negative pressure provided from an intake passage of an intake system of an internal combustion engine and supplies the generated negative pressure to a negative pressure chamber of a brake booster; and
determining whether there is a blockage in the ejector system according to a difference between a pressure in the negative pressure chamber and the negative pressure provided from the intake passage.

15. A control method of an ejector system for a vehicle, comprising:
rendering operational an ejector which generates negative pressure that is greater than negative pressure provided from an intake passage of an intake system of an internal combustion engine and supplies the generated negative pressure to a negative pressure chamber of a brake booster; and
determining whether there is a blockage in the ejector system according to a change in pressure in the negative pressure chamber.

16. A control method of an ejector system for a vehicle, comprising:
rendering operational an ejector that has an inlet side connecting portion and an outlet side connecting portion which are connected to an intake passage of an intake system of an internal combustion engine, a negative pressure generating portion that generates negative pressure from intake air flowing between the inlet side connecting portion and the outlet side connecting portion, and a negative pressure supply connecting portion that is communicated with the negative pressure generating portion and also connected to a brake booster; and
determining whether there is a blockage in the ejector system according to a change in at least one pressure, from among the pressure generated between the intake passage and the inlet side connecting portion, the pressure generated between the intake passage and the outlet side connecting portion, and the pressure generated between the negative pressure generating portion and the negative pressure supply connecting portion.
